(19) United States
(12) Patent Application Publication
(10) Pub. No.: US 2018/0368341 A1
(43) Pub. Date: Dec. 27, 2018

(54) WATER STORAGE SYSTEM AND MANUFACTURING METHOD THEREFOR

(71) Applicant: Shenzhen Huaguoshan Ecological Technology Co., LTD, Shenzhen City (CN)

(72) Inventors: Jianjun Wang, Hohhot City (CN); Lei Wang, Hohhot City (CN)

(21) Appl. No.: 16/016,820

(22) Filed: Jun. 25, 2018

(30) Foreign Application Priority Data
Jun. 27, 2017 (CN) 201710498946.9
Jun. 27, 2017 (CN) 201710499036.2
Jun. 27, 2017 (CN) 201710499138.4
Jun. 27, 2017 (CN) 201710499160.9
Jun. 27, 2017 (CN) 201710499184.4

(51) Int. Cl. A01G 27/00; A01G 27/02; E01C 11/22; C04B 28/02; C04B 14/06; C04B 14/10; B01J 20/12; B01J 20/10; B01J 20/30

(52) U.S. Cl. CPC A01G 27/006; A01G 27/02; E01C 11/225; C04B 28/02; C04B 14/068; B28B 1/14; B01J 20/12; B01J 20/103; B01J 20/3021; B01J 20/3007; C04B 14/104

(57) ABSTRACT

The present invention discloses a water storage system, comprising: a water storage brick, a water storage stick and a water storage unit, wherein the water storage stick and the water storage brick are made of construction waste, so as to realize recycling of the construction waste and achieve the effects of protecting the environment and saving resources. The water storage unit uses a mixture of the construction waste, a water retaining agent and an organic or inorganic fertilizer as a culture substrate, so as to retain water and increase the fertilizer. Because the resource utilization of the construction waste is realized, a good environmental protection effect can be achieved. The present invention provides a water storage system and a manufacturing method therefor, so as to effectively solve the problem of difficult water supply for greening and tree planting in arid and water shortage regions, benefit the improvement on an ecological environment, increase a vegetation coverage rate and bring important significance to resource utilization of rainwater and construction of the ecological environment.

### TECHNICAL FIELD

The present invention relates to the technical field of water storage, and in particular to a water storage system and a manufacturing method therefor.

### BACKGROUND

Desertification means decline or loss of soil productivity caused by wind erosion, water erosion, soil salinization, etc. The definition adopted at the world conference on environment and development in 1992 is “land deterioration in arid, semiarid and subhumid regions caused by various factors including climate and human activities”. According to the United Nations Environment Programme (UNEP), 35% of the land area of the world is already and is expected to be affected by desertification, wherein Africa accounts for 55%, North America and Central America account for 19%, South America accounts for 10%, Asia accounts for 34%, Australia accounts for 75% and Europe accounts for 2%. About 60,000 to 100,000 square kilometers of land suffers from desertification each year on average in the world. Over the past half century, desertification land in sub-saharan in Africa has increased by 650,000 square kilometers. The total land area of the world is 162 million square kilometers, accounting for 30.3% of the total land area of the earth. Desert area already accounts for 10% of the total land area, and 43% of the land is facing the threat of desertification.

Arid regions have fragile ecological environments, and face the major environmental problems of serious soil and water loss, land desertification and the shortage of water resources. Vegetation construction with soil and water conservation as the core plays an important role in maintaining ecological balance and improving the ecological environments in the arid regions. Therefore, to protect and improve the ecological environments, expand forest area and increase vegetation coverage rate, afforestation is imperative. But because traditional afforestation projects need a lot of water resources to maintain the survival rate of trees and landscape scenery, desertification control and forestry construction projects face enormous challenges in the arid regions that lack of water resources and seriously lack of water in soil. If rainwater as a natural and valuable water source can be fully collected and used in afforestation projects in the arid regions in the scarcity of water resources today, the problem of difficult water supply for greening and tree planting in arid and water shortage regions can be effectively solved and an important significance to resource utilization of the rainwater and construction of the ecological environments is brought.

Therefore, how to provide a water storage system which is beneficial for improving the ecological environments, increasing the survival rate and the coverage rate of vegetation and reducing maintenance is a problem to be urgently solved by those skilled in the art.

### SUMMARY

In view of this, the present invention provides a water storage system and a manufacturing method therefor, so as to effectively solve the problem of difficult water supply for greening and tree planting in arid and water shortage regions, benefit the improvement on an ecological environment, increase a vegetation survival rate and a vegetation coverage rate and bring important significance to resource utilization of rainwater and construction of the ecological environment.

To achieve the above purpose, the present invention provides the following technical solution:

A water storage system comprises: any one or a combination of more of a water storage brick, a water storage stick and a water storage unit,

wherein the water storage brick is provided with a plurality of permeable holes; the permeable holes penetrate through the water storage brick, and are used to store water;

the water storage stick comprises a hollow water storage stick or a solid water storage stick; the hollow water storage stick is a hollow structure which is used to store the water; the solid water storage stick is a solid structure, and a sunken groove is formed in the upper end of the solid structure; the solid water storage stick stores the water through the solid structure;

the water storage unit comprises: a water storage device, a water collecting pipe, a water inlet conduit, a water diversion conduit, a micro leaky pipe, a three-way pipe, a hydroscopic substance and a silt sedimentation pipe;

the water storage system further comprises: a rainwater collecting unit arranged above the water storage unit and used to collect external rainwater; the rainwater collecting unit comprises: a collector, and the water collecting pipe penetrates through the collector;

the water inlet conduit is installed at a water inlet in the upper part of the water storage device, and an opening of the water inlet conduit is upward; the water diversion conduit is installed at a water diversion port on one side of the water inlet of the water storage device, and an opening of the water diversion conduit faces a plant; one end of the micro leaky pipe is connected with a water outlet of the water storage device, and the other end of the micro leaky pipe comes into contact with a plant root system; one end of the hydroscopic substance is placed in the water storage device through the water diversion conduit, and the other end of the hydroscopic substance comes into contact with the plant root system; stored rainwater in the water storage device is supplied to the plant root system through the micro leaky pipe and the hydroscopic substance; a first water outlet of the three-way pipe is connected with the water inlet conduit; a second water outlet of the three-way pipe is connected with the silt sedimentation pipe; an end of the silt sedimentation pipe is provided with a movable plug detachably connected with the silt sedimentation pipe; and a water inlet of the three-way pipe is connected with the water collecting pipe.

Through the above technical solution, the present invention has the following technical effects: the water storage brick has good water permeability, water retentivity and water absorption; the water storage brick can be used in lawn greening, can change wastes into valuables and protect the environment, and can also realize automatic water storage, water retention and water saving, thereby reducing artificial watering cost and contributing to transformation to become a water-saving park; due to the water absorption and water retention characteristics of the water storage stick, the water storage stick is used in culturing plants (or seeds) in dry regions, so as to solve the problem of difficult greening in the dry regions and achieve the purposes of no maintenance and no artificial watering, saving the cost and saving water resources; the water storage unit can effectively complete automatic collection of rainwater, automatic storage of rainwater and automatic release of water, so as to collect rainwater into the water storage device and slowly supply the rainwater to a tree root system; in a long period of tree cultivation and growth, natural precipitation is effectively used and the water is uniformly supplied, thereby solving the problem of difficult water supply for tree planting in arid and water shortage regions and providing a more scientific, effective, and easy-operation and implementation method for the construction and development of the forestry; and nursery stock planted through the method has high survival rate, thereby saving water consumption for construction of greening projects, achieving the purpose of saving water resources, greatly increasing afforestation efficiency and expanding greening area.

Preferably, in the above water storage system, a film is wrapped or a sleeve pipe is sleeved outside the water storage stick.

Preferably, in the above water storage system, the water storage unit also comprises a sand prevention hood, a water collecting hole and a filter screen layer; the sand prevention hood is installed on the top end of the water collecting pipe; at least one water collecting hole is formed in the side wall of the upper end of the water collecting pipe; and the filter screen layer close to the internal wall is located in the water collecting pipe at the edge below the water inlet of the upper end of the water collecting pipe.

By adopting the above technical solution, the present invention has the following beneficial effects:

(1) The sand prevention hood is installed on the top end of the water collecting pipe, and the filter screen layer is disposed closely to the inner side wall of the water collecting pipe;

(2) The silt sedimentation pipe is installed below the three-way pipe; the movable plug is installed at the end of the silt sedimentation pipe; and if silt enters and precipitates on the bottom of the silt sedimentation pipe, the movable plug is opened for the convenience of eliminating the silt;

(3) The micro leaky pipe is installed on the bottom of the water storage device at a distance of 5-10 cm to prevent the silt on the bottom of the water storage device from precipitating and affecting a water penetration effect of the micro leaky pipe;

(4) The water absorption conduit is a bent conduit and prevents the silt from entering.

A manufacturing method for a water storage system comprises the specific steps:

step 1: crushing and sorting the construction wastes to obtain aggregates with different particle diameters;
step 2: mixing the aggregates with different particle diameters in accordance with a predetermined gradation in order to form a graded construction waste mixture; step 3: adding cement, silver sand, a water retaining agent, bentonite and water to the graded construction waste mixture, and uniformly stirring to form a pouring mixture;
step 4: pouring the pouring mixture into a prefabricated mould for fabricating the water storage stick or water storage brick; and removing the mould after the pouring mixture is solidified, to form a water storage stick blank or water storage brick blank; and
step 5: maintaining the water storage stick blank or water storage brick blank to form a water storage stick or water storage brick.

Through the above technical solution, the present invention has the following beneficial effects: the construction waste is made into the water storage brick or the water storage stick by the present invention, so as to realize recycling of the construction waste and achieve the effects of protecting the environment and saving resources. The water storage brick or the water storage stick made by the present invention has good water retention and water absorption characteristics, and is applied to construction of ecological water saving lawns. The rainwater or artificial watering can be naturally stored into the water storage brick and slowly supplied to the plant. Meanwhile, evaporation of water on the ground is reduced and downward infiltration of the water is reduced, thereby avoiding wasting the water.

Preferably, in the manufacturing method for the water storage system, the construction waste comprises waste bricks and concrete blocks, and a proportion of the waste bricks to the concrete blocks is greater than 4:6.

Preferably, in the above manufacturing method for the water storage system, the range of the mass percentage of the aggregates with different particle diameters in the graded construction waste mixture is: 15%-25% of aggregates with a particle diameter of 0.2-1 cm, 15%-25% of aggregates with a particle diameter of 1-2 cm, 25%-55% of aggregates with a particle diameter of 2-4 cm and 15%-25% of aggregates with a particle diameter of 4-6 cm.

Preferably, in the above manufacturing method for the water storage system, the mass percentages of the aggregates with different particle diameters in the graded construction waste mixture are: 20% of aggregates with a particle diameter of 0.2-1 cm, 20% of aggregates with a particle diameter of 1-2 cm, 40% of aggregates with a particle diameter of 2-4 cm and 20% of aggregates with a particle diameter of 4-6 cm.

Preferably, in the manufacturing method for the water storage system, the content of soil in the pouring mixture is less than or equal to 3%.

Preferably, in the manufacturing method for the water storage system, a ratio of parts by weight of the cement, the silver sand, the graded construction waste mixture, the water retaining agent, the bentonite and the water in the pouring mixture is:

the cement:the silver sand:the graded construction waste mixture:the water retaining agent:the bentonite:the water=1:2:7:0.063:0.031:0.4.

Preferably, the water storage unit is applied as:

a culture substrate paved on the bottom of a tree well and used to provide nutrition for saplings;

a water storage unit placed in the tree well;

a water release unit placed between the water storage unit and a sapling root system and used to supply rainwater stored in the water storage unit to the sapling root system; and

a rainwater collecting unit placed above the water storage unit, used to collect external rainwater and connected with the water storage unit to store the rainwater collected by the rainwater collecting unit into the water storage unit and supply the rainwater to the sapling root system through the water release unit.

It can be known from the above technical solution that, compared with the prior art, the present invention provides a water storage system and a manufacturing method therefor, so as to effectively solve the problem of difficult water supply for greening and tree planting in arid and water shortage regions, benefit the improvement on an ecological environment, increase a vegetation coverage rate and bring important significance to resource utilization of rainwater and construction of the ecological environment. The water storage brick has good water permeability, water retentivity and water absorption; the water storage brick can be used in lawn greening, can change wastes into valuables and protect the environment, and can also realize automatic water storage, water retention and water saving, thereby reducing artificial watering cost and contributing to transformation to become a water-saving park; due to the water absorption and water retention characteristics of the water storage stick, the water storage stick is used in culturing plants (or seeds) in dry regions, so as to solve the problem of difficult greening in the dry regions and achieve the purposes of no maintenance and no artificial watering, saving the cost and saving water resources; the water storage unit can effectively complete automatic collection of rainwater, automatic storage of rainwater and automatic release of water, so as to collect rainwater into the water storage device and slowly supply the rainwater to a tree root system; in a long period of tree cultivation and growth, natural precipitation is effectively used and the water is uniformly supplied, thereby solving the problem of difficult water supply for tree planting in arid and water shortage regions and providing a more scientific, effective, and easy-operation and implementation method for the construction and development of the forestry; and nursery stock planted through the method has high survival rate, thereby saving water consumption for construction of greening projects, achieving the purpose of saving water resources, greatly increasing afforestation efficiency and expanding greening area.

### BRIEF DESCRIPTION OF THE DRAWINGS

To more clearly describe the technical solution in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a frame diagram of the present invention.

FIG. 2 is a structural schematic diagram of a water storage brick of the present invention.

FIG. 3 is a top view of combination of water storage bricks and construction waste clasts in the present invention.

FIG. 4 is a sectional view of combination of water storage bricks and construction waste clasts in the present invention.

FIG. 5 is a structural schematic diagram of a hollow water storage stick during use in the present invention.

FIG. 6 is a sectional view of a hollow water storage stick with a circular cross section made by a method of the present invention.

FIG. 7 is a sectional view of a hollow water storage stick with a square cross section made by a method of the present invention.

FIG. 8 is a sectional view of a hollow water storage stick with a rectangular cross section made by a method of the present invention.

FIG. 9 is a structural schematic diagram of a solid water storage stick during use in the present invention.

FIG. 10 is a sectional view of a solid water storage stick with a circular cross section made by a method of the present invention.

FIG. 11 is a sectional view of a solid water storage stick with a square cross section made by a method of the present invention.

FIG. 12 is a sectional view of a solid water storage stick with a rectangular cross section made by a method of the present invention.

FIG. 13 is a diagram of a use effect of a water storage unit of the present invention.

FIG. 14 is a top view of a water storage unit of the present invention.

FIG. 15 is a structural schematic diagram of a water storage unit of the present invention.

FIG. 16 is a flow chart of preparation of a water storage stick or water storage brick in the present invention.

In the figures: 1 sand prevention hood; 2 water collecting hole; 3 filter screen layer; 4 water collecting pipe; 5 water inlet pipe; 6 water diversion conduit; 7 water storage device; 8 collector; 9 three-way pipe; 10 silt sedimentation pipe; 11 movable plug; 12 hydroscopic substance; 13 micro leaky pipe; 14 planting hole; 15 culture substrate; 16 water storage brick; 17 permeable hole; 18 film; 19 soil matrix; 20 hollow water storage stick; 21 underground wet soil layer; 22 dry soil layer; 23 underground water; 24 solid water storage stick; and 25 construction waste clast.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

Embodiments of the present invention disclose a water storage system and a manufacturing method therefor, so as to effectively solve the problem of difficult water supply for greening and tree planting in arid and water shortage regions, benefit the improvement on an ecological environment, increase a vegetation coverage rate and bring important significance to resource utilization of rainwater and construction of the ecological environment.

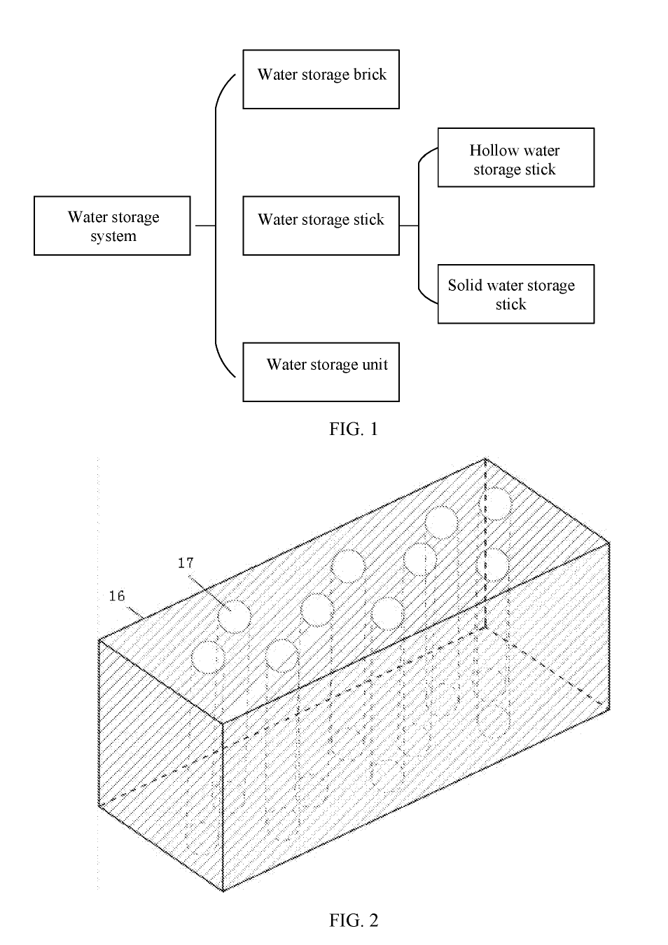

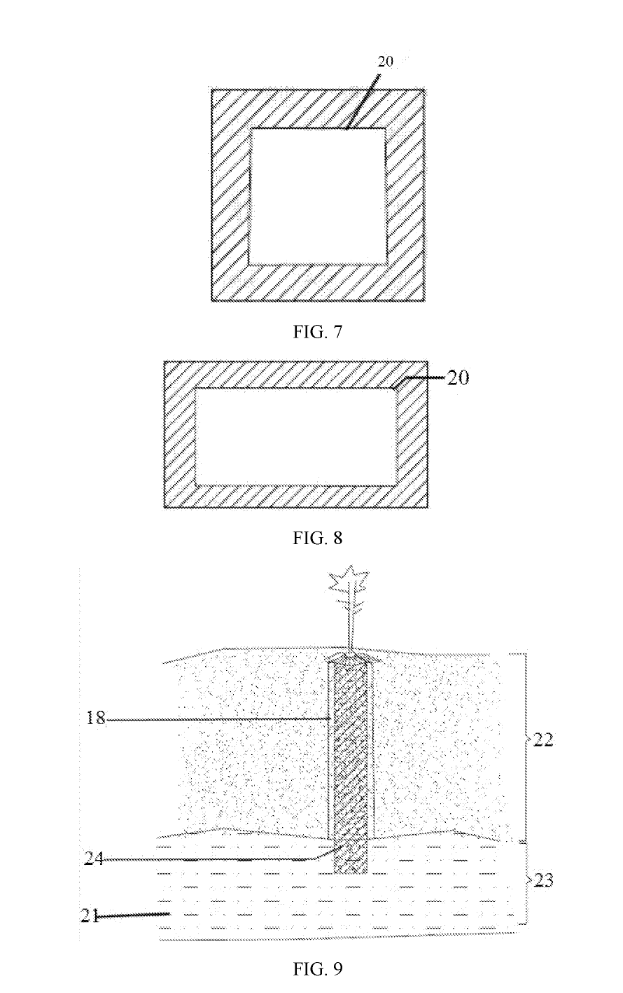

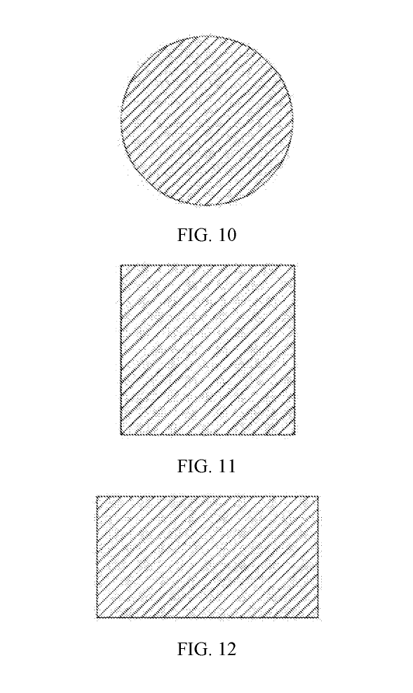

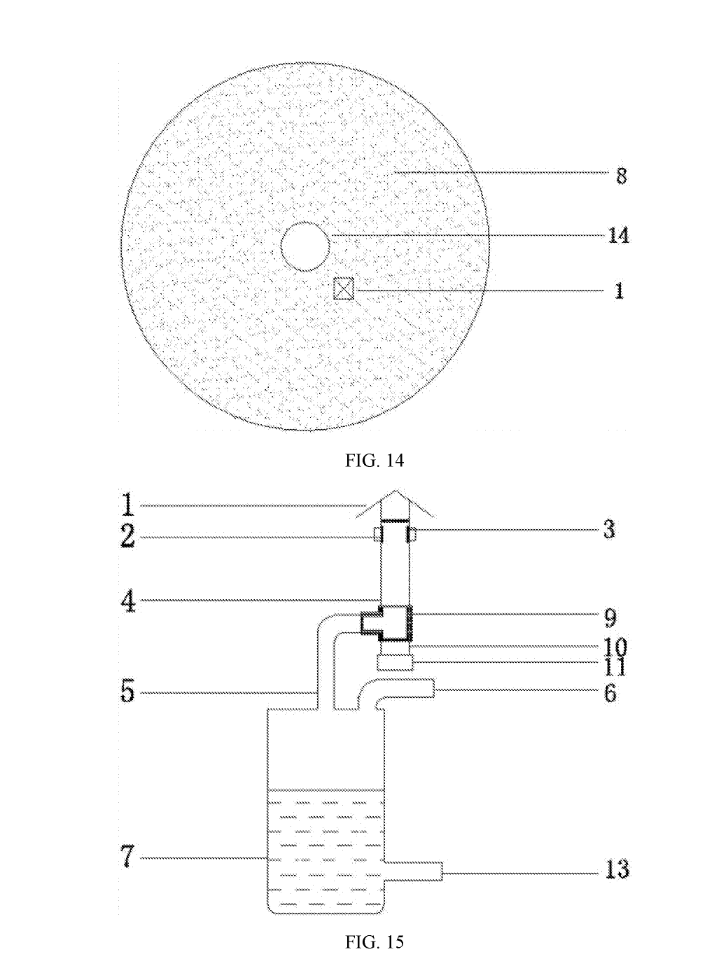

As shown in FIG. 1 to FIG. 15, a water storage system comprises: any one or a combination of more of a water storage brick 16, a water storage stick and a water storage unit,

wherein the water storage brick 16 is provided with a plurality of permeable holes 17; the permeable holes 17 penetrate through the water storage brick 16, and are used to store water;

the water storage stick comprises a hollow water storage stick 20 or a solid water storage stick 24; the hollow water storage stick 20 is a hollow structure which is used to store the water; the solid water storage stick 24 is a solid structure, and a sunken groove is formed in the upper end of the solid structure; the solid water storage stick 24 stores the water through the solid structure;

the water storage unit comprises: a water storage device 7, a water collecting pipe 4, a water inlet conduit 5, a water diversion conduit 6, a micro leaky pipe 13, a three-way pipe 9, a hydroscopic substance 12 and a silt sedimentation pipe 10;

the water storage system further comprises: a rainwater collecting unit arranged above the water storage unit and used to collect external rainwater; the rainwater collecting unit comprises: a collector 8, and the water collecting pipe 4 penetrates through the collector 8; and

the water inlet conduit 5 is installed at a water inlet in the upper part of the water storage device 7, and an opening of the water inlet conduit 5 is upward; the water diversion conduit 6 is installed at a water diversion port on one side of the water inlet of the water storage device 7, and an opening of the water diversion conduit 6 faces a plant; one end of the micro leaky pipe 13 is connected with a water outlet of the water storage device 7, and the other end of the micro leaky pipe 13 comes into contact with a plant root system; one end of the hydroscopic substance 12 is placed in the water storage device 7 through the water diversion conduit 6, and the other end of the hydroscopic substance 12 comes into contact with the plant root system; stored rainwater in the water storage device 7 is supplied to the plant root system through the micro leaky pipe 13 and the hydroscopic substance 12; a first water outlet of the three-way pipe 9 is connected with the water inlet conduit 5; a second water outlet of the three-way pipe 9 is connected with the silt sedimentation pipe 10; an end of the silt sedimentation pipe 10 is provided with a movable plug 11 detachably connected with the silt sedimentation pipe 10; and a water inlet of the three-way pipe 9 is connected with the water collecting pipe 4.

To further optimize the above technical solution, a film 18 is wrapped or a sleeve pipe is sleeved outside the water storage stick.

To further optimize the above technical solution, the water storage unit also comprises: a sand prevention hood 1, a water collecting hole 2 and a filter screen layer 3; the sand prevention hood 1 is installed on the top end of the water collecting pipe 4; at least one water collecting hole 2 is formed in the side wall of the upper end of the water collecting pipe 4; and the filter screen layer 3 close to the internal wall is located in the water collecting pipe 4 at the edge below the water inlet of the upper end of the water collecting pipe 4.

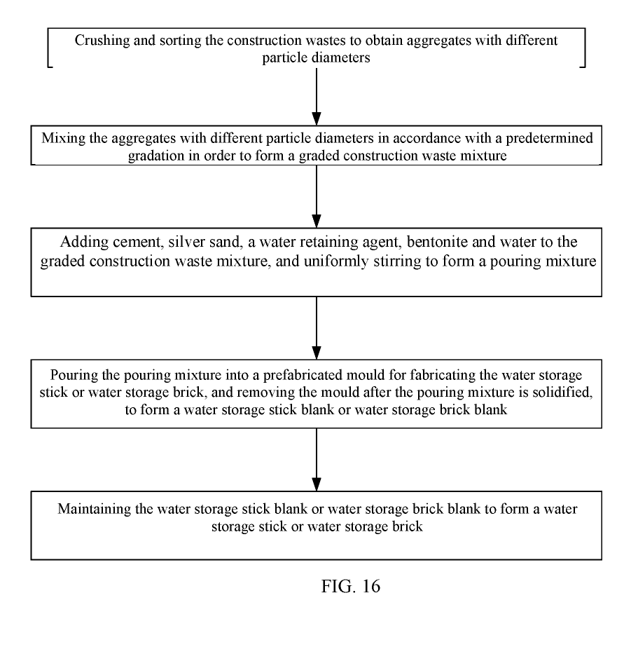

As shown in FIG. 16, a manufacturing method for a water storage system comprises the specific steps:

step 1: crushing and sorting the construction wastes to obtain aggregates with different particle diameters;
step 2: mixing the aggregates with different particle diameters in accordance with a predetermined gradation in order to form a graded construction waste mixture; step 3: adding cement, silver sand, a water retaining agent, bentonite and water to the graded construction waste mixture, and uniformly stirring to form a pouring mixture;
step 4: pouring the pouring mixture into a prefabricated mould for fabricating the water storage stick or water storage brick 16; and removing the mould after the pouring mixture is solidified, to form a water storage stick blank or water storage brick blank; and
step 5: maintaining the water storage stick blank or water storage brick blank to form a water storage stick or water storage brick 16.

To further optimize the above technical solution, the construction waste comprises waste bricks and concrete blocks, and a proportion of the waste bricks to the concrete blocks is greater than 4:6.

To further optimize the above technical solution, the range of the mass percentage of the aggregates with different particle diameters in the graded construction waste mixture is: 15%-25% of aggregates with a particle diameter of 0.2-1 cm, 15%-25% of aggregates with a particle diameter of 1-2 cm, 25%-55% of aggregates with a particle diameter of 2-4 cm and 15%-25% of aggregates with a particle diameter of 4-6 cm.

To further optimize the above technical solution, the mass percentages of the aggregates with different particle diameters in the graded construction waste mixture are: 20% of aggregates with a particle diameter of 0.2-1 cm, 20% of aggregates with a particle diameter of 1-2 cm, 40% of aggregates with a particle diameter of 2-4 cm and 20% of aggregates with a particle diameter of 4-6 cm.

To further optimize the above technical solution, the content of soil in the pouring mixture is less than or equal to 3%.

To further optimize the above technical solution, a ratio of parts by weight of the cement, the silver sand, the graded construction waste mixture, the water retaining agent, the bentonite and the water in the pouring mixture is: the cement:the silver sand:the graded construction waste mixture:the water retaining agent:the bentonite:the water=1:2:7:0.063:0.031:0.4.

To further optimize the above technical solution, the water storage unit is applied as: a culture substrate 15 paved on the bottom of a tree well and used to provide nutrition for saplings;

a water storage unit placed in the tree well;

a water release unit placed between the water storage unit and a sapling root system and used to supply rainwater stored in the water storage unit to the sapling root system; and

a rainwater collecting unit placed above the water storage unit, used to collect external rainwater and connected with the water storage unit to store the rainwater collected by the rainwater collecting unit into the water storage unit and supply the rainwater to the sapling root system through the water release unit.

Description is made below according to different characteristics of a water storage stick or water storage brick 16 made by components of different proportions in the method of the present invention. It is known from the above that, when the graded construction waste mixture is made, the range of the mass percentages of the aggregates with different particle diameters shall satisfy the following conditions:

| | |
|---|---|
| 0.2-1 cm | 15%-25% |
| 1-2 cm | 15%-25% |
| 2-4 cm | 25%-55% |
| 4-6 cm | 15%-25% |

When the pouring mixture is made, a ratio of parts by weight of the adopted components shall satisfy the following conditions:

the cement:the silver sand:the graded construction waste mixture:the water retaining agent:the bentonite:the water=1:2:7:0.063:0.031:0.4.

### Example 1

The mass percent of the aggregates with particle diameters in the graded construction waste mixture is as follows:

| | |
|---|---|
| 0.2-1 cm | 20% |
| 1-2 cm | 20% |
| 2-4 cm | 40% |
| 4-6 cm | 20% |

When the components in the pouring mixture adopt the following proportion: the cement:the silver sand:the graded construction waste mixture:the water retaining agent:the bentonite:the water=1:2:7:0.063:0.031:0.4, the manufactured water storage stick or water storage brick 16 has many pores; the pores have an appropriate spacing; and many water storage bags capable of storing water are formed, and have good water absorption, good water permeability, good compressive strength and good water storage function.

### Example 2

The mass percent of the aggregates with particle diameters in the graded construction waste mixture is as follows:

| | |
|---|---|
| 0.2-1 cm | 10% |
| 1-2 cm | 10% |
| 2-4 cm | 50% |
| 4-6 cm | 30% |

When the components in the pouring mixture adopt the following proportion: the cement:the silver sand:the graded construction waste mixture:the water retaining agent:the bentonite:the water=1:3:8:0.063:0.011:0.3, compared with example 1, the manufactured water storage stick or water storage brick 16 has large water absorption, poor water permeability, low compressive strength and poor water storage performance.

### Example 3

The mass percent of the aggregates with particle diameters in the graded construction waste mixture is as follows:

| | |
|---|---|
| 0.2-1 cm | 30% |
| 1-2 cm | 30% |
| 2-4 cm | 30% |
| 4-6 cm | 10% |

When the components in the pouring mixture adopt the following proportion: the cement:the silver sand:the graded construction waste mixture:the water retaining agent:the bentonite:the water=1:3:8:0.063:0.011:0.3, compared with example 1, the manufactured water storage stick or water storage brick 16 has small water absorption, large water permeability, low compressive strength and poor water storage performance.

### Embodiment 1

A mould of the water storage brick 16 adopted in the present invention can be made of steel or fiber reinforced plastics, and is a cylindrical mould in a shape of a cuboid; a main body which penetrates through the thickness of the mould is disposed in the mould in order to enable the manufactured water storage brick 16 to be in a long bar shape. A plurality of permeable holes 17 (as shown in FIG. 2) are formed in the water storage brick 16.

Generally, the specification of the water storage brick 16 is 400×200×100 mm or 500×200×100 mm in a shape of a rectangular bar. The diameter of the permeable holes 17 formed in the water storage brick 16 is generally 1-2 cm as long as the plurality of permeable holes 17 are away from the edge of the water storage brick 16; and the plurality of permeable holes 17 can be uniformly disposed in the water storage brick 16. When a lawn is paved on the water storage brick 16, a plant root system of the lawn can continue to root towards the deep soil through the permeable holes 17.

When the water storage brick 16 is manufactured, the pouring mixture is directly poured into the mould of the water storage brick 16. Or, a plastic bag or plastic film 18 with a corresponding specification is lined in the mould of the water storage brick 16. During use, the pouring mixture is poured into the plastic bag or plastic film 18 located in the mould.

In addition, the mould of the water storage brick 16 in the present invention can be made of other materials.

The water storage brick 16 made by the method of the present invention can be applied to the field of lawn paving. During application, one or more layers of water storage bricks 16 are paved at first; and then lawns are planted on the water storage bricks 16. Planting can be conducted through the following two methods:

1) horizontally paving 3 cm-5 cm of planting soil on the water storage bricks 16, and paving a sod on the planting soil; and

2) horizontally paving 10 cm of planting soil on the water storage bricks 16, and planting grass seeds in the planting soil.

### Embodiment 2

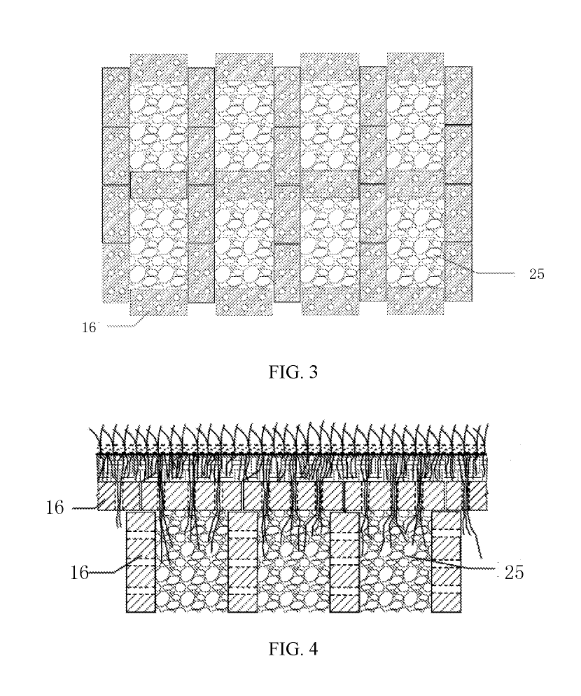

As shown in FIG. 3 to FIG. 4, the water storage bricks 16 are matched with the construction waste clasts. The water storage bricks 16 are divided into upper water storage bricks and lower water storage bricks. The permeable holes of the upper water storage bricks are paved perpendicularly to the ground, and the permeable holes of the lower water storage bricks are paved parallel to the ground. The water storage bricks form hollow structures. The construction waste clasts 25 are filled in the hollow structures, thereby realizing water storage.

### Embodiment 3

A mould of the water storage stick adopted in the present invention can be made of steel or fiber reinforced plastics. A plastic bag or plastic film 18 with a corresponding specification is lined in the mould. During use, the pouring mixture is poured into the plastic bag or plastic film 18 located in the mould. After the pouring mixture is solidified, the mould is removed and a water storage stick blank, together with the plastic bag or plastic film 18, is taken out and maintained, so as to obtain the water storage stick having the plastic bag or plastic film 18.

Or, the mould of the water storage stick of the present invention can also be made of a PVC pipe. The mixture is poured into the mould of the PVC pipe. After the mixture is solidified, the mixture is maintained together with the PVC pipe, so as to obtain the water storage stick or water storage brick 16 having the PVC pipe. In the subsequent use process, the water storage stick having the PVC pipe can be directly buried into soil with abundant water without the need of wrapping the PVC pipe by using the plastic film 18.

In addition, the mould of the water storage stick in the present invention can be made of other materials.

The cross section of the mould of the water storage stick in the present invention can be prefabricated to be circular, rectangular or square. The dimension of the mould can be set according to concrete conditions during use of the water storage stick.

During design, the mould of the water storage stick may be a hollow cylindrical mould so that the water storage stick poured through the cylindrical mould is a solid water storage stick 24, or the mould of the water storage stick may be a sleeve-shaped mould in which the center is a solid cylinder and a sleeve pipe with an internal diameter greater than the diameter of the cylinder is sleeved outside the cylinder, so that the water storage stick poured through the sleeve-shaped mould is a hollow water storage stick 20.

If the solid water storage stick 24 is manufactured, a downward protruded cone or curve shall be disposed on the upper surface of the mould of the water storage stick in the manufacturing process, so that the upper end of the manufactured water storage stick has a downward groove, i.e., the upper end of the water storage stick is a surface that the surrounding edges are high and the center is downward sunk into the cone or bowl, so as to increase the plant root system during use or increase the contact area with the water storage stick after the seeds germinate.

The water storage stick made by the method of the present invention can be applied to the field of revegetation of arid regions. During application, firstly, an earth auger is used to excavate pits used for placing the water storage stick; then the water storage stick made by the above method is rapidly placed into the pit and plants or seeds are planted on the water storage stick; and planting can be conducted through a conventional method.

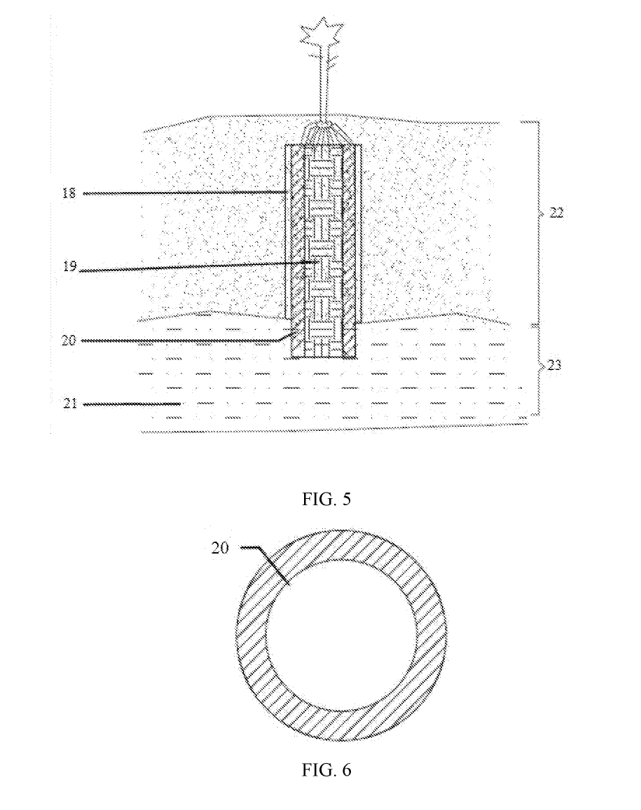

During application, if the water storage stick is a hollow water storage stick 20, the soil matrix 19 shall be added at the hollow position of the hollow water storage stick 20 so that upper plants (or seeds), when growing, root downwards through the soil matrix 19 (as shown in FIG. 5). If the water storage stick is a solid water storage stick 247, the water storage stick is directly placed into the excavated pit and the plants or seeds are put into the groove above the water storage stick; and the plants or seeds can be planted through the conventional method (as shown in FIG. 9).

When the pits used for placing the water storage stick are excavated, the bottoms of the pits shall be located on the underground wet soil layer 21 filled with underground water 23 so that the lower end of the water storage stick placed in the pit can absorb water in the underground wet soil layer 21 and convey the water upward along the water storage stick until the water is conveyed to the upper end of the water storage stick located on the dry soil layer 22 with less water, so that the plants or seeds planted on the upper end of the water storage stick can acquire the water to benefit the growth.

The water storage stick made by the method of the present invention has the advantages of simple structure and good water absorption and water retention characteristics, and can be used for planting the plants or seeds in arid desert regions, so as to solve the problem of difficult greening in the arid desert regions. In the process of plant growth, because the water storage stick can continuously absorb the water from the underground wet soil layer 21, the plants do not need maintenance and artificial watering, thereby saving manual cost and saving water resources.

### Embodiment 4

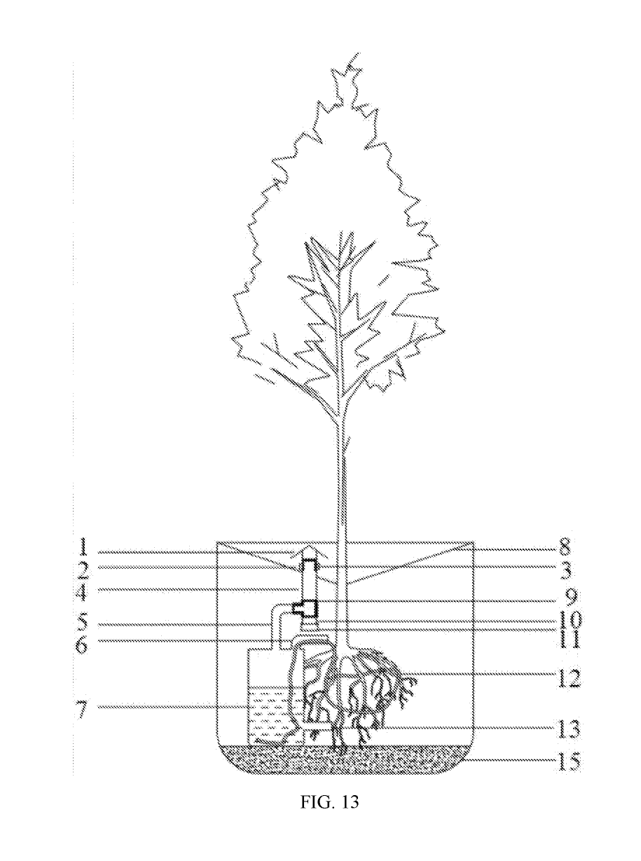

Specifically, as shown in FIG. 13 to FIG. 15, the use steps of the water storage unit are:

S01: excavating a tree well and paving a culture substrate used for providing nutrition for saplings on the bottom of the tree well, wherein the diameter and the depth of the excavated tree well shall be greater than the diameter and the depth of a soil ball of a tree to be planted (i.e., soil included in the root system of the tree) by about 30 cm.

After the tree well is excavated, the culture substrate 15 with certain thickness is paved on the bottom of the tree well. The culture substrate is formed by a mixture of different types of construction wastes with different particle diameters, the water retaining agent and the organic or inorganic fertilizer.

The mixture of the construction wastes, the water retaining agent and the organic or inorganic fertilizer is used as the culture substrate, so as to retain water and increase the fertilizer. Because the resource utilization of the construction wastes is realized, a good environmental protection effect can be achieved.

S02: Placing the sapling above the culture substrate 15 and placing the water storage unit into the tree well.

After the sapling is placed above the culture substrate 15, a water storage device 7 used for water storage is placed on the bottom of the root of the sapling so that a water outlet at the lower part of the water storage device 7 faces the root of the sapling. The water inlet conduit 5 is installed at the water inlet at the upper part of the water storage device 7 and an opening of the water inlet conduit 5 is upward. Preferably, the water inlet conduit 5 may be a bent conduit, i.e., the water inlet conduit 5 has a vertical pipe connected with the water inlet of the water storage device 7, and a horizontal pipe vertically connected with the vertical pipe; and an opening of the horizontal pipe faces the sapling.

The water storage device 7 may be in any shape, has corrosion-resistant performance and can be made of plastics or anti-corrosion metal. The water inlet is located at the top of the water storage device 7, and the water outlet is 5-10 cm away from the bottom of the water storage device 7.

S03: Placing a water release unit between the water storage unit and a sapling root system so as to supply rainwater stored in the water storage unit to the sapling root system through the water release unit, specifically comprising the following steps:

S31: Installing the water diversion conduit 6 at a water diversion port of the water storage device 7 located on one side of the water inlet of the water storage device 7, and enabling an opening of the water diversion conduit 6 to face the sapling.

Preferably, the water diversion conduit 6 may be a bent conduit, i.e., the water diversion conduit 6 has a vertical pipe connected with a water diversion port of the water storage device 7, and a horizontal pipe vertically connected with the vertical pipe; and an opening of the horizontal pipe faces the sapling. During manufacture, the vertical pipe and the horizontal pipe are integrated in one piece, while the water diversion conduit 6 and the water diversion port of the water storage device 7 can be connected in a detachable mode, such as connection through thread or inserting mode, connection in a undetachable mode, and connection through welding or bonding or fusing.

S32: Placing one end of the hydroscopic substance 12 in the water storage device 7 through the water diversion conduit 6 of the water storage device 7, so that one end of the hydroscopic substance 12 extends to the bottom of the water storage device 7 and extends out by a part, and making the other end of the hydroscopic substance 12 come into contact with the sapling root system (i.e., the soil ball),wherein when the hydroscopic substance 12 is selected and the length of the hydroscopic substance 12 is determined, the hydroscopic substance 12 shall be placed in the water storage device and comes into contact with the sapling root system and then both ends of the hydroscopic substance 12 can be respectively exposed by 5-10 cm. When the material of the hydroscopic substance is selected, the material with strong water absorption is generally selected to make the hydroscopic substance. For example, gauze can be used to make the hydroscopic substance.

The water diversion conduit 6 of the present invention is a bent conduit and can effectively prevent the silt in the water storage device 7 from entering the sapling root system through the hydroscopic substance 12 and impeding the growth of the sapling.

S33: Connecting one end of the micro leaky pipe 13 with a water outlet at the lower part of the water storage device 7, and placing the other end of the micro leaky pipe 13 at the sapling root system and making the other end come into contact with the sapling root system. The micro leaky pipe 13 may be a pipe with a diameter of 3-5 mm.

Because the micro leaky pipe 13 of the present invention is installed in a position higher than the bottom of the water storage device 7 by 5-10 cm, the silt precipitated on the bottom of the water storage device 7 can be effectively prevented from blocking the micro leaky pipe 13 and affecting a water penetration effect of the micro leaky pipe.

The stored rainwater in the water storage device is slowly supplied to the sapling root system through the micro leaky pipe and the hydroscopic substance so that the water is supplied uniformly in the long period of sapling cultivation and growth and the survival rate of afforestation is greatly enhanced.

S04: Injecting water on the bottom of the tree well; fixing the sapling with soil; placing the water storage unit between the water storage unit and the sapling root system; then completely filling the bottom of the tree well with water; after planting and burying the sapling with soil through a conventional tree planting method, correcting the tree well into a shape with a low middle part and a high edge; and making the tree well in a horizontal concave shape in order to use the tree well to form a rainwater collecting unit that benefits the collection of the rainwater. In the process of fixing the sapling, the water inlet conduit 5 and the sapling shall be exposed from the upper surface of the tree well in parallel.

S05: Placing a rainwater collector above the water storage unit for collecting external rainwater.

S51: After the sapling is fixed, connecting the water inlet conduit 5 of the water storage device 7 with a first water outlet of the three-way pipe 9, connecting a second water outlet of the three-way pipe 9 with the silt sedimentation pipe 10 and connecting a water inlet of the three-way pipe 9 with the water collecting pipe 4.

The water inlet of the three-way pipe 9 and the second water outlet are located on the same axis; the water inlet is vertically upward, and the second water outlet is vertically downward; and the first water outlet and the water inlet (or the second water outlet) are perpendicular and extend horizontally towards the direction away from the sapling. Because the second water outlet of the three-way pipe 9 is vertically downward and is connected with the silt sedimentation pipe 10, the silt that enters the water from the water collecting pipe 4 can fall into the silt sedimentation pipe 10 and precipitate in the silt sedimentation pipe 10, while the water without the silt flows into the water inlet conduit 5 through the first water outlet so as to flow into the water storage device 7 for storage.

Preferably, the silt sedimentation pipe 10 adopts a pipe with a length of 5-10 cm. The movable plug 11 detachably connected with the silt sedimentation pipe is disposed at the end of the silt sedimentation pipe, so that the movable plug 11 can be removed when too much silt exists in the silt sedimentation pipe 10 so as to eliminate the silt in the silt sedimentation pipe 10 in time.

S52: After three ports of the three-way pipe 9 are respectively connected with corresponding pipelines, paving a collector 8 for collecting the rainwater on the upper surface of the parabolic tree well and enabling the upper part of the water collecting pipe 4 to penetrate through the collector 8.

The collector 8 can be made of a film with an anti-seepage function. The film is paved on the upper surface of the tree well and is cut according to the diameter and the depth of the tree well so that the film is finally in a turbinate shape. Namely, a turbinate collector 8 is formed so as to facilitate the collection of the rainwater and prevent the rainwater from flowing out.

When the film is paved, a planting hole 14 through which the top of the sapling penetrates shall be formed in the middle of the film.

S53: After the film is paved, disposing the filter screen layer 3 close to the internal wall in the water collecting pipe 4 at the edge below the water inlet of the upper end of the water collecting pipe 4 so that sand carried in the rainwater that enters from the water inlet is filtered through the filter screen layer 3, wherein the filter screen layer 3 may include one or more layers of filter screens and the aperture of the mesh of the filter screens is not greater than 5 mm.

One or more water inlets can be formed in the side wall of the upper end of the water collecting pipe 4, and a plurality of water inlets can be annularly disposed in the side wall of the water collecting pipe 4.

S54: After the filter screen layer 3 is placed on the water collecting pipe 4, placing the sand prevention hood 1 used for preventing sand wind from entering the water collecting pipe 4 onto the top of the water collecting pipe 4, wherein the sand prevention hood 1 may be conical and is covered at the top opening of the water collecting pipe 4.

S55: Finally, filling original soil on the upper part of the film, and compacting the film until the filled original soil is appropriate for the planting height of the sapling.

Through the method of the present invention, when rain falls, the collector collects the rainwater. When the collected rainwater reaches a certain height, the rainwater can flow into the water collecting pipe 4 from the water collecting hole 2. The silt carried in the rainwater precipitates in the silt sedimentation pipe 10, while the rainwater without the silt flows into the water storage device 7 through the water inlet conduit 5 for storage. On one hand, the water stored in the water storage device 7 is slowly supplied to the sapling root system through the hydroscopic substance. On the other hand, after the water stored in the water storage device 7 reaches a certain height, the water is supplied to the sapling root system through the micro leaky pipe 13 so that the rainwater is supplied to the sapling to enable the sapling to grow.

Specifically, the culture substrate of the present invention is a mixture formed by the construction wastes, the water retaining agent and the organic or inorganic fertilizer. Through the adoption of the culture substrate, water is retained and the fertilizer is increased. Because the resource utilization of the construction wastes is realized, a good environmental protection effect can be achieved.

The water storage unit of embodiments of the present invention can adopt the structure shown in FIG. 13 to FIG. 15, including: the water storage device 7 placed in the tree well, wherein the water outlet at the lower part of the water storage device 7 faces the sapling; and the water inlet conduit 5 installed at the water inlet in the upper part of the water storage device 7, wherein the opening of the water inlet conduit 5 is upward. The upper surface of the tree well of the present invention has a paraboloid shape with a low middle part and a high edge, and the water inlet conduit 5 and the sapling are exposed from the upper surface of the tree well in parallel.

The water storage device 7 in the present embodiment may be in any shape, has corrosion-resistant performance and can be made of plastics or anti-corrosion metal. The water inlet is located at the top of the water storage device 7, and the water outlet is 5-10 cm away from the bottom of the water storage device 7.

Preferably, the water inlet conduit 5 may be a bent conduit, i.e., the water inlet conduit 5 has a vertical pipe connected with the water inlet of the water storage device 7, and a horizontal pipe vertically connected with the vertical pipe; and an opening of the horizontal pipe faces the sapling.

The water diversion conduit 6 is installed at a water diversion port on one side of the water inlet of the water storage device 7, and an opening of the water diversion conduit 6 faces the sapling. One end of the micro leaky pipe 13 is connected with a water outlet of the water storage device 7, and the other end of the micro leaky pipe 13 comes into contact with the sapling root system. One end of the hydroscopic substance 12 is placed in the water storage device 7 through the water diversion conduit 6 of the water storage device 7, and the other end of the hydroscopic substance 12 comes into contact with the sapling root system. The stored rainwater in the water storage device 7 is supplied to the sapling root system through the micro leaky pipe 13 and the hydroscopic substance 12.

Preferably, the water diversion conduit 6 in the present embodiment is a bent conduit, i.e., the water diversion conduit 6 has a vertical pipe connected with a water diversion port of the water storage device 7, and a horizontal pipe vertically connected with the vertical pipe; and an opening of the horizontal pipe faces the sapling. During manufacture, the vertical pipe and the horizontal pipe are integrated in one piece, while the water diversion conduit 6 and the water diversion port of the water storage device 7 can be connected in a detachable mode, such as connection through thread or inserting mode, connection in a undetachable mode, and connection through welding or bonding or fusing.

When the hydroscopic substance 12 is selected and the length of the hydroscopic substance 12 is determined, the hydroscopic substance 12 shall be placed in the water storage device and comes into contact with the sapling root system and then both ends of the hydroscopic substance 12 can be respectively exposed by 5-10 cm. When the material of the hydroscopic substance is selected, the material with strong water absorption is generally selected to make the hydroscopic substance. For example, gauze can be used to make the hydroscopic substance. Preferably, a plurality of hydroscopic substances may be arranged. One end of each of the plurality of hydroscopic substances is respectively inserted into the water storage device through the water diversion conduit and the other end of each of the plurality of hydroscopic substances is arranged around the sapling root system.

Because the water diversion conduit 6 of the present invention is a bent conduit, the silt in the water storage device 7 can be effectively prevented from entering the sapling root system through the hydroscopic substances 12 and impeding the growth of the sapling.

The micro leaky pipe 13 of the present invention may be a pipe with a diameter of 3-5 mm. Because the micro leaky pipe 13 of the present invention is installed in a position higher than the bottom of the water storage device 7 by 5-10 cm, the silt precipitated on the bottom of the water storage device 7 can be effectively prevented from blocking the micro leaky pipe 13 and affecting a water penetration effect of the micro leaky pipe.

The rainwater collecting unit of embodiments of the present invention comprises: the three-way pipe 9 with a first water outlet connected with the water inlet conduit 5 of the water storage device 7; the silt sedimentation pipe 10 connected with the second water outlet of the three-way pipe 9; and the water collecting pipe 4 connected with the water inlet of the three-way pipe 9. Preferably, at least one water collecting hole 2 is formed in the side wall of the upper end of the water collecting pipe 4.

The water inlet of the three-way pipe 9 and the second water outlet are located on the same axis; the water inlet is vertically upward, and the second water outlet is vertically downward; and the first water outlet and the water inlet (or the second water outlet) are perpendicular and extend horizontally towards the direction away from the sapling. Because the second water outlet of the three-way pipe 9 is vertically downward and is connected with the silt sedimentation pipe 10, the silt that enters the water from the water collecting pipe 4 can fall into the silt sedimentation pipe 10 and precipitate in the silt sedimentation pipe 10, while the water without the silt flows into the water inlet conduit 5 through the first water outlet so as to flow into the water storage device 7 for storage.

Preferably, the silt sedimentation pipe 10 adopts a pipe with a length of 5-10 cm. The movable plug 11 detachably connected with the silt sedimentation pipe is disposed at the end of the silt sedimentation pipe, so that the movable plug 11 can be removed when too much silt exists in the silt sedimentation pipe 10 so as to eliminate the silt in the silt sedimentation pipe 10 in time.

The collector 8 can be made of a film with an anti-seepage function. The film is paved on the upper surface of the tree well and is cut according to the diameter and the depth of the tree well so that the film is finally in a turbinate shape. Namely, a turbinate collector 8 is formed so as to facilitate the collection of the rainwater and prevent the rainwater from flowing out. The planting hole 14 through which the top of the sapling penetrates shall be formed in the middle of the film.

The filter screen layer 3 may include one or more layers of filter screens and the aperture of the mesh of the filter screens is not greater than 5 mm. One or more water inlets can be formed in the side wall of the upper end of the water collecting pipe 4, and a plurality of water inlets can be annularly disposed in the side wall of the water collecting pipe 4. The sand prevention hood 1 placed onto the top of the water collecting pipe 4 and used for preventing the sand wind from entering the water collecting pipe 4 may be conical and is covered at the top opening of the water collecting pipe 4.

Compared with the prior art, the water storage unit provided by the present invention has the following beneficial effects:

1) The water storage unit provided by the present invention can effectively complete automatic collection of rainwater, automatic storage of rainwater and automatic release of water, so as to collect rainwater into the water storage device and slowly supply the rainwater to a tree root system; in a long period of tree cultivation and growth, natural precipitation is effectively used and the water is uniformly supplied, thereby solving the problem of difficult water supply for tree planting in arid and water shortage regions and providing a more scientific, effective, and easy-operation and implementation method for the construction and development of the forestry; and nursery stock planted through the method has high survival rate, thereby saving water consumption for construction of greening projects, achieving the purpose of saving water resources, greatly increasing afforestation efficiency and expanding greening area. Therefore, the present invention has important practical significance to the development of forestry and the repair of the ecological environment, such as desertification control.

2) The water storage unit provided by the present invention has multiple functions for preventing the silt from precipitating and blocking:

(1) The sand prevention hood is installed on the top end of the water collecting pipe, and the filter screen layer is disposed closely to the inner side wall of the water collecting pipe;

(2) The silt sedimentation pipe is installed below the three-way pipe; the movable plug is installed at the end of the silt sedimentation pipe; and if silt enters and precipitates on the bottom of the silt sedimentation pipe, the movable plug is opened for the convenience of eliminating the silt;

(3) The micro leaky pipe is installed on the bottom of the water storage device at a distance of 5-10 cm to prevent the silt on the bottom of the water storage device from precipitating and affecting a water penetration effect of the micro leaky pipe;

(4) The water absorption conduit is a bent conduit and prevents the silt from entering.

3) The water storage unit provided by the present invention has wide applicability, and can be applied to planting arbor, bush, etc. The size and the placing depth of the water storage device can be regulated according to hydrological conditions and morphological properties of the plant (such as diameter at breast height and diameter of vertical projection plane). The placing depth of the device is appropriately increased through the hydrotaxis of the root system, so as to achieve the purposes of guiding the root system to go downwards and guiding the root system to grow downwards.

4) In the water storage unit provided by the present invention, a plurality of water supply points are disposed for the sapling in the horizontal direction and the vertical direction and the hydroscopic substances and the micro leaky pipe in the device are combined in multiple modes, thereby increasing a water absorption surface of the tree root system. In accordance with the capillary action and the micro seepage principle, the collected rainwater is slowly supplied to the tree root system through the hydroscopic substances and the micro leaky pipe. Thus, in the long period of tree cultivation and growth, the tree can uniformly acquire the water, achieving the purpose of omnibearing water supply. Further, the normal physiological function of the tree is maintained, and a more scientific and feasible method for afforestation in arid and water shortage regions is provided.

5) In the water storage unit provided by the present invention, the mixture of the construction waste, the water retaining agent and the organic or inorganic fertilizer is used as the culture substrate, so as to retain water and increase the fertilizer. Because the resource utilization of the construction waste is realized, a good environmental protection effect can be achieved.

6) The water storage unit provided by the present invention has the advantages of easy acquirement of raw materials, low cost, long period of validity and low later management expense, fully reflects the requirement for the development of the ecosystem for sustainable regulation of water, and is beneficial for improving the ecological environment of soil water for growth of the tree root system.

7) The water storage unit provided by the present invention can be widely applied to ecological repair projects such as afforestation and desertification control in arid and water shortage regions, will generate enormous environmental benefits, social benefits and economic benefits and has broad market prospects.

### Embodiment 5

The water storage bricks and the water storage sticks are combined for use. The water storage bricks are paved and covered with sod. The water storage bricks and the water storage sticks are arranged alternately, and the upper parts of the water storage sticks can be used for planting trees.

### Embodiment 6

The water storage bricks and the water storage units are combined for use. The water storage bricks are paved and covered with sod. The water storage bricks and the water storage units are arranged alternately, and the upper parts of the water storage units can be used for planting trees.

### Embodiment 7

The water storage sticks and the water storage units are combined for use. The water storage sticks and the water storage units are arranged alternately. This combination mode is used for forest construction in arid regions.

### Embodiment 8

The water storage bricks, the water storage sticks and the water storage units are combined for use. The water storage bricks are paved and covered with sod. The upper parts of the water storage sticks and the water storage units are used for planting trees.

Embodiments 5-8 involve the structures of the water storage bricks, the water storage sticks and the water storage units, and will not be repeated.

Each embodiment in the description is described in a progressive way. The difference of each embodiment from each other is the focus of explanation. The same and similar parts among all of the embodiments can be referred to each other. For a device disclosed by the embodiments, because the device corresponds to a method disclosed by the embodiments, the device is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

1. A water storage system, comprising: any one or a combination of more of a water storage brick, a water storage stick and a water storage unit,
wherein the water storage brick is provided with a plurality of permeable holes; the permeable holes penetrate through the water storage brick, and are used to store water;
the water storage stick comprises a hollow water storage stick or a solid water storage stick; the hollow water storage stick is a hollow structure which is used to store the water; the solid water storage stick is a solid structure, and a sunken groove is formed in the upper end of the solid structure; the solid water storage stick stores the water through the solid structure;
the water storage unit comprises: a water storage device, a water collecting pipe, a water inlet conduit, a water diversion conduit, a micro leaky pipe, a three-way pipe, a hydroscopic substance and a silt sedimentation pipe;
the water storage system further comprises: a rainwater collecting unit arranged above the water storage unit and used to collect external rainwater; the rainwater collecting unit comprises: a collector, and the water collecting pipe penetrates through the collector; and
the water inlet conduit is installed at a water inlet in the upper part of the water storage device, and an opening of the water inlet conduit is upward; the water diversion conduit is installed at a water diversion port on one side of the water inlet of the water storage device, and an opening of the water diversion conduit faces a plant; one end of the micro leaky pipe is connected with a water outlet of the water storage device, and the other end of the micro leaky pipe comes into contact with a plant root system; one end of the hydroscopic substance is placed in the water storage device through the water diversion conduit, and the other end of the hydroscopic substance comes into contact with the plant root system; stored rainwater in the water storage device is supplied to the plant root system through the micro leaky pipe and the hydroscopic substance; a first water outlet of the three-way pipe is connected with the water inlet conduit; a second water outlet of the three-way pipe is connected with the silt sedimentation pipe; an end of the silt sedimentation pipe is provided with a movable plug detachably connected with the silt sedimentation pipe; and a water inlet of the three-way pipe is connected with the water collecting pipe.

2. The water storage system according to claim 1, wherein a film is wrapped or a sleeve pipe is sleeved outside the water storage stick.

3. The water storage system according to claim 1, wherein the water storage unit also comprises: a sand prevention hood, a water collecting hole and a filter screen layer; the sand prevention hood is installed on the top end of the water collecting pipe; at least one water collecting hole is formed in the side wall of the upper end of the water collecting pipe; and the filter screen layer close to the internal wall is located in the water collecting pipe at the edge below the water inlet of the upper end of the water collecting pipe.

4. A manufacturing method for a water storage system, comprising the specific steps:
step 1: crushing and sorting the construction wastes to obtain aggregates with different particle diameters; and
step 2: mixing the aggregates with different particle diameters in accordance with a predetermined gradation in order to form a graded construction waste mixture; step 3: adding cement, silver sand, a water retaining agent, bentonite and water to the graded construction waste mixture, and uniformly stirring to form a pouring mixture;
step 4: pouring the pouring mixture into a prefabricated mould for fabricating the water storage stick or water storage brick; and removing the mould after the pouring mixture is solidified, to form a water storage stick blank or water storage brick blank; and
step 5: maintaining the water storage stick blank or water storage brick blank to form a water storage stick or water storage brick.

5. The manufacturing method for the water storage system according to claim 4, wherein the construction waste comprises waste bricks and concrete blocks, and a proportion of the waste bricks to the concrete blocks is greater than 4:6.

6. The manufacturing method for the water storage system according to claim 5, wherein the range of the mass percentage of the aggregates with different particle diameters in the graded construction waste mixture is: 15%-25% of aggregates with a particle diameter of 0.2-1 cm, 15%-25% of aggregates with a particle diameter of 1-2 cm, 25%-55% of aggregates with a particle diameter of 2-4 cm and 15%-25% of aggregates with a particle diameter of 4-6 cm.

7. The manufacturing method for the water storage system according to claim 6, wherein the mass percentages of the aggregates with different particle diameters in the graded construction waste mixture are: 20% of aggregates with a particle diameter of 0.2-1 cm, 20% of aggregates with a particle diameter of 1-2 cm, 40% of aggregates with a particle diameter of 2-4 cm and 20% of aggregates with a particle diameter of 4-6 cm.

8. The manufacturing method for the water storage system according to claim 7, wherein the content of soil in the pouring mixture is less than or equal to 3%.

9. The manufacturing method for the water storage system according to claim 4, wherein a ratio of parts by weight of the cement, the silver sand, the graded construction waste mixture, the water retaining agent, the bentonite and the water in the pouring mixture is:
the cement:the silver sand:the graded construction waste mixture:the water retaining agent:the bentonite:the water=1:2:7:0.063:0.031:0.4.

10. The water storage system according to claim 1, wherein the water storage unit is applied as: a culture substrate paved on the bottom of a tree well and used to provide nutrition for saplings;
a water storage unit placed in the tree well;
a water release unit placed between the water storage unit and a sapling root system and used to supply rainwater stored in the water storage unit to the sapling root system; and
a rainwater collecting unit placed above the water storage unit, used to collect external rainwater and connected with the water storage unit to store the rainwater collected by the rainwater collecting unit into the water storage unit and supply the rainwater to the sapling root system through the water release unit.
